(19) United States
(12) Patent Application Publication
(10) Pub. No.: US 2012/0036671 A1
(43) Pub. Date: Feb. 16, 2012

(54) WINDSCREEN WIPER DEVICE

(76) Inventor: Xavier Boland, Arlon (BE)

(21) Appl. No.: 13/265,941

(22) PCT Filed: Apr. 24, 2009
(86) PCT No.: PCT/EP2009/055007

§ 371 Date: Oct. 24, 2011

(51) Int. Cl. B60S 1/32; B60S 1/34; B60S 1/42

(52) U.S. Cl. 15/250.32

(57) ABSTRACT

A windscreen wiper device, particularly for automobiles, comprising an elastic, elongated carrier element, as well as an elongated wiper blade of a flexible material, which can be placed in abutment with a windscreen to be wiped, which wiper blade is of the flat blade type and includes at least one groove, in which groove a longitudinal strip of the carrier element is disposed, wherein the windscreen wiper device further comprises a mounting head for transferring a reciprocal movement to the wiper blade, with the special feature that the windscreen wiper device further comprises a connecting device for detachably connecting the wiper blade directly to the mounting head, wherein the connecting device is positioned near one end of the wiper blade, and wherein the connecting device, at the location of its attachment to the mounting head, is located in its entirety inside the mounting head.

### BACKGROUND OF THE INVENTION

1. Technical Field

The invention relates to a windscreen wiper device, particularly for automobiles, comprising an elastic, elongated carrier element, as well as an elongated wiper blade of a flexible material, which can be placed in abutment with a windscreen to be wiped, which wiper blade is of the flat blade type and includes at least one groove, in which groove a longitudinal strip of the carrier element is disposed, wherein the windscreen wiper device further comprises a mounting head for transferring a reciprocal movement to the wiper blade.

It is noted that the present invention is not restricted to cars, but also refers to rail coaches and other (fast) vehicles.

2. Related Art

Such a windscreen wiper device is known from European patent publication no. 1 514 752 (Federal-Mogul S. A.). The windscreen wiper device described in this European patent publication comprises a mounting head mountable on a drive shaft and an arm member pivotally connected to the mounting head by means of a pivot pin, wherein the aim member has a substantially U-shaped cross-section near the pivot pin comprising two side walls, wherein a part of the mounting head extends between the side walls and beyond the pivot pin.

A disadvantage of the windscreen wiper arm known from the above European patent publication is that it comprises many complex parts with a dedicated shape, wherein reference is made to the oscillating arm described therein consisting of a plastic arm member at one end thereof pivotally connected to a mounting head by means of a pivot pin and at the other end thereof folded around a rod-like part. Obviously, this needs complex machinery, tools, with all the expenses involved.

### SUMMARY OF THE INVENTION

It is an object of the invention to obviate this disadvantage, in the sense that at minimum costs—without using complex machinery and additional tools—a simple though effective windscreen wiper device is proposed which fits on all kinds of different cars.

Thereto, according to the invention a windshield wiper arm mentioned in the preamble is characterized in that the windscreen wiper device further comprises a connecting device for detachably connecting the wiper blade directly to the mounting head, wherein the connecting device is positioned near one end of the wiper blade, and wherein the connecting device, at the location of its attachment to the mounting head, is located in its entirety inside the mounting head. Preferably, the windscreen wiper device further comprises a connecting piece positioned near the other end of the wiper blade and connected to one end of the longitudinal strip. The wiper arm according to the present invention refrains from the use of an intermediate oscillating arm, thereby avoiding an articulation between the oscillating arm and the wiper blade, as well as between the mounting head and the oscillating arm. This not only ensures that less parts have to be used in manufacturing the windscreen wiper device with all advantages involved (such as cheaper, lighter, less plastic material sensitive to UV-light), but also that disadvantages like wear are obviated.

Further, by directly connecting the connecting device to the mounting head, the wiper blade is mounted closer to the windscreen to be wiped, so that the wiping properties are improved. Also, by locating the connecting device in its entirety inside the mounting head, a very strong connection between is formed that can withstand large torque. Advantageously, the connecting device and the connecting piece are connected to the wiper blade at opposite ends thereof.

The connecting device and the mounting head are each preferably made of one piece. The present windscreen wiper device is particularly designed for use at a rear window of a car.

Preferably, the wiper blade includes opposing longitudinal grooves on its longitudinal sides, in which grooves spaced-apart longitudinal strips of the carrier element are disposed, wherein neighbouring ends of the longitudinal strips are interconnected by the connecting device at one end of the wiper blade and by the connecting piece at the other end of the wiper blade. the connecting device may be glued, soldered, clipped, snapped or welded onto the longitudinal strips.

In a preferred embodiment of a windscreen wiper device in accordance with the invention the mounting head, at the location of its attachment to the connecting device, comprises engaging members engaging around longitudinal sides and around a bottom of the connecting device, so that the connecting device is mounted in a channel formed by the engaging members.

In a further preferred embodiment of a windscreen wiper device in accordance with the invention the mounting head has an at least substantially U-shaped cross-section at the location of its attachment to the connecting device wherein the engaging members comprise legs of the U-shaped cross-section, and wherein each leg at the free end thereof comprises inwardly bended edges engaging around the bottom of the connecting device.

In a further preferred embodiment of a windscreen wiper device in accordance with the invention the mounting head has an at least substantially O-shaped cross-section at the location of its attachment to the connecting device, wherein the engaging members comprise sides of the O-shaped cross-section.

In a further preferred embodiment of a windscreen wiper device in accordance with the invention the strip and the connecting device are slidably connected by means of a snap connection.

In a further preferred embodiment of a windscreen wiper device in accordance with the invention the snap connecting comprises at least one protrusion extending laterally from a longitudinal edge of the strip, the protrusion being located between stops on the connecting device.

In a further preferred embodiment of a windscreen wiper device in accordance with the invention the snap connecting comprises at least two stops extending laterally from a longitudinal edge of the strip, the stops being located on opposite sides of a protrusion on the connecting device.

In a further preferred embodiment of a windscreen wiper device in accordance with the invention the protrusion and/or the stops of the strip extend laterally from the interior or exterior edge of the strip.

In a further preferred embodiment of a windscreen wiper device in accordance with the invention the longitudinal strip is biassed in such a way that its curvature radius near the connecting device is smaller than that its curvature radius near the other end of the wiper blade, all seen in dismounted position. in other words, in dismounted position the wiper blade has an asymmetric shape, seen along its middle transverse plane perpendicular to a windscreen to be wiped. Thus, the wiper blade is able to follow any curvature of a windscreen to be wiped, while the wiper blade is pressed onto the windscreen to be wiper with sufficient force to enhance the wiping properties.

In a further preferred embodiment of a windscreen wiper device according to the invention the interconnection between the mounting head and the wiper blade does not allow any pivotal movement. In other words, in mounted position the mounting head and the connecting device cannot move relative to one another, i.e. are stationary with respect to each other.

In a further preferred embodiment of a windscreen wiper device in accordance with the invention the mounting head is fixed for rotation to a shaft, wherein the shaft is rotatable alternately in a clockwise and in a counterclockwise sense carrying the mounting head into rotation. Thus, in turn the mounting head draws the connecting device into rotation and thereby moves the wiper blade. In the alternative, the mounting head is fixed for translation to a carriage, wherein the carriage can be translated alternately in a one linear direction and in another counter linear direction carrying the mounting head into translation. The present invention can therefore be used for circular or linear movement of the mounting head.

In a further preferred embodiment of a windscreen wiper device according to the invention the connecting device comprises at least one resilient tongue engaging in a correspondingly shaped hole provided in the mounting head, and wherein the resilient tongue is movable between a outward position retaining the wiper blade onto the mounting head and an inward position releasing the wiper blade from the mounting head. In order to connect the wiper blade onto the mounting head, the resilient tongue is initially pushed in against a spring force—as if it were a push button—and then allowed to spring back into the hole provided in the mounting head, thus snapping, that is clipping the resilient tongue into the hole. By subsequently pushing in again the resilient tongue against the spring force, the wiper blade may be released from the mounting head. Particularly, the hole has a closed circumference. Preferably, the resilient tongue is hingeable along an hinge axis, wherein the hinge axis is orientated towards the mounting head (so that the resilient tongue opens away from the mounting head) or facing away from the mounting head near an outer edge of the joint part (so that the resilient tongue opens towards the mounting head). Particularly, the hinge axis is located at an outer edge of the connecting device.

In a further preferred embodiment of a windscreen wiper device according to the invention the hole is provided in a base of the U-shaped or O-shaped cross-section of the mounting head. In this embodiment the resilient tongue may be provided on an upper part of the connecting device. In addition thereto or instead thereof the connecting device may be provided with at least two lateral resilient tongues extending outwardly, wherein each tongue engages in a correspondingly shaped hole provided in each leg of the U-shaped or O-shaped cross-section of the mounting head. the holes preferably have a closed circumference. Such closed holes enhance the retention of the connection device onto the mounting head in all possible directions, particularly both horizontally and vertically.

### THE DRAWINGS

The invention will now be explained in more detail with reference to figures illustrated in a drawing, wherein;

FIG. 1 is a perspective, schematic and exploded view of a preferred embodiment of a windscreen wiper device in accordance with the invention;

FIG. 2 shows several perspective, schematic views of a mounting head as used in FIG. 1;

FIG. 3 shows various successive steps for fitting the connecting device and the mounting head of FIG. 2 together;

FIG. 4 is a perspective, schematic and exploded view of another preferred embodiment of a windscreen wiper device in accordance with the invention;

FIG. 5 relates to several views of a connecting device of FIGS. 1 and 4.

### DETAILED DESCRIPTION

The windscreen wiper device 1 is built up of an elastomeric wiper blade 2, in the longitudinal sides of which opposing longitudinal grooves 3 are formed, and of longitudinal strips 4 made of spring band steel, which are fitted in the longitudinal grooves 3. The strips 4 form a flexible carrier element for the wiper blade 2, as it were, which is thus biassed in a curved position (the curvature in operative position being that of a windscreen to be wiped). Neighbouring ends 5 of the strips 4 at one end of the wiper blade 2 are interconnected by means of a connecting piece 6 or “end cap” functioning as clamping member. In this embodiment, the connecting piece 6 is a separate constructional element, which may be form-locked (“positive locking” or “having a positive fit”) or force-locked to the ends 5 of the strips 4. In another preferred embodiment, the connecting piece 6 is in one piece with the strips 4 made of spring band steel. In the latter case the connecting piece 6 forms a transverse bridge for the strips 4, as it were.

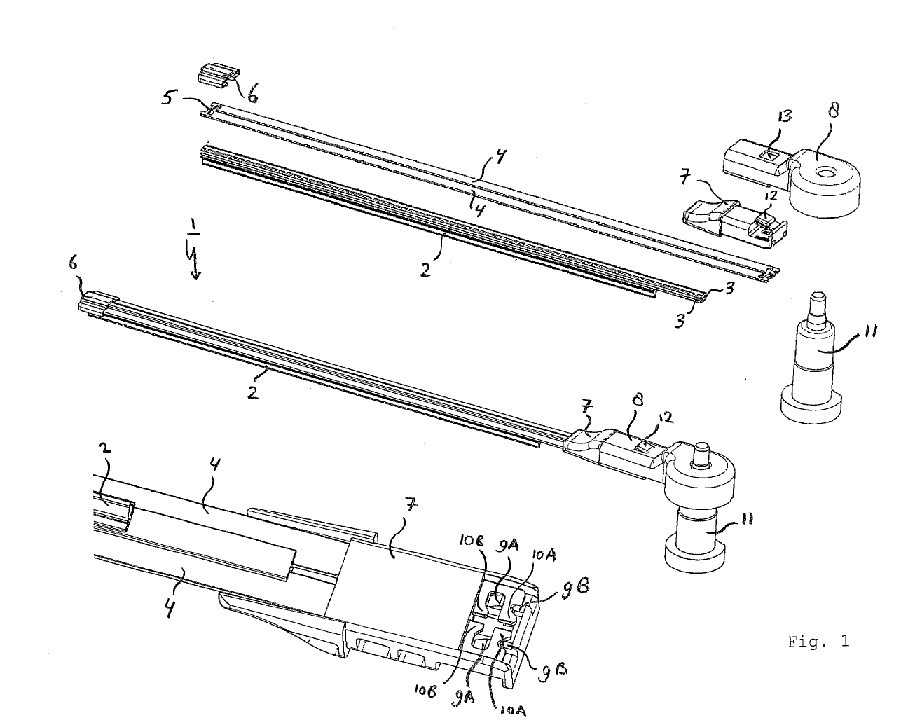

The windscreen wiper device 1 is furthermore built up of a connecting device 7 of plastic material for a mounting head 8. Alternatively, the connecting device 7 may also be made of metal, such as steel or aluminum. As can be seen, the connecting device 7 is connected to the wiper blade 2 at its other end, that is opposite the connecting piece 6. The connecting device 7 engages around strips 4 and comprises protrusions or stops 9 extending from the connecting device 7 in the direction of the bottom part of the connecting device 7, which is the part facing the windscreen (not shown). Strips 4 comprise protrusions or stops 10, extending laterally from a longitudinal edge of strips 4. In FIG. 1, the protrusions or stops 10 extend laterally from the exterior edge of strips 4, but they can also extend from the interior edge. Strips 4 are slidably connected to the connecting device by means of a snap connection formed by the protrusions/stops 9 of the connecting device 7 and protrusions/stops 10 of strips 4, wherein the protrusions 10A of the strips 4 extend between the stops 9 of the connecting device 7, and wherein the stops 10 of the strips 4 extend around the protrusions 9A of the connecting device 7. As a result, the connecting device 7 is firmly attached to the unit consisting of the wiper blade 2 and the strips 4.

As illustrated in FIGS. 1 through 5 the windscreen wiper device I according to the invention comprises a plastic or metallic mounting head 8 which can be fixed for rotation to a shaft 11 driven, via a mechanism not illustrated, by a small motor. In use, the shaft 11 rotates alternately in a clockwise and in a counter-clockwise sense carrying the mounting head 8 into rotation also, which in turn draws the connecting device 7 in rotation and thereby moves the wiper blade 2.

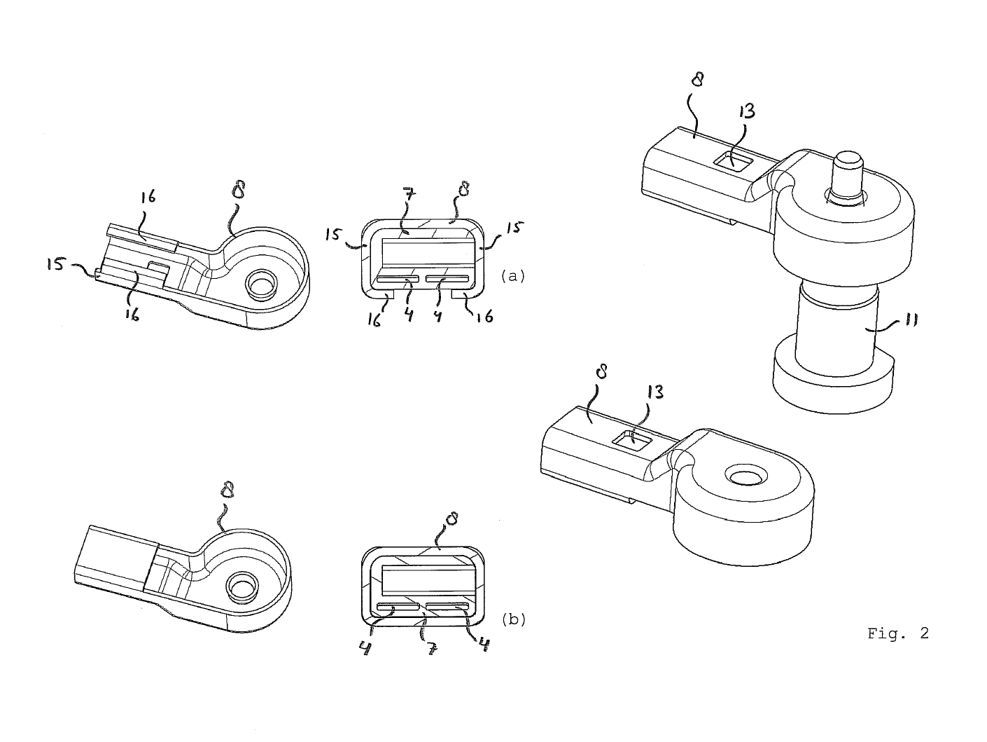

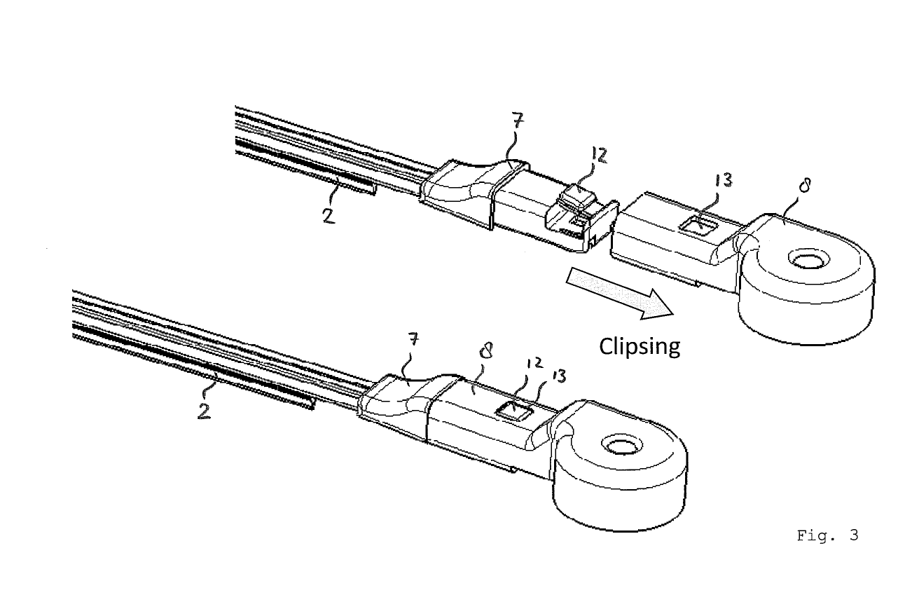

With reference to FIGS. 2 and 3 the connecting device 7 comprises one resilient tongue 12 extending outwardly, while the mounting head 8 has an U-shaped (FIG. 2a) or O-shaped (FIG. 2b) cross-section at the location of its connection to the connecting device 7, so that the tongue 12 engages in an identically shaped hole 13 provided in a base 14 of the U/O-shaped cross-section.

FIG. 3 shows the steps of mounting the connecting device 7 with the wiper blade 2 onto the mounting head 8. The connecting device 7 can be easily slid in horizontal direction on a free end of the mounting head 8. During this sliding movement the resilient tongue 12 is initially pushed in against a spring force and then allowed to spring back into the hole 13, thus snapping, that is clipping the resilient tongue 12 into the hole 13. This is a so-called bayonet-connection. The mounting head 8 together with the connecting device 7 are then ready for use. By subsequently pushing in again the resilient tongue 12 against the spring force (as if it were a push button), the connecting device 7 together with the wiper blade 2 may be released from the mounting head 8. Dismounting the connecting device 7 with the wiper blade 2 from the mounting head 8 is thus realized by sliding the connecting device 7 together with the wiper blade 2 in a direction away from the mounting head 8.

FIG. 2a shows that the U-shaped cross-section is formed by engaging members of the mounting head 8, which comprise legs 15 and inwardly bended edges 16 integral with the legs 15, wherein during use the legs 15 engage around longitudinal sides of the connecting device 7 that face away from each other and the inwardly bended edges 16 engage around the bottom part of the connecting device 7 that faces the windscreen (not shown). The bottom part can also be identified as the part facing away from the part of the connecting device 7 that comprises the resilient tongue 12. Instead of a U-shaped cross-section of the mounting head 8 it can be an O-shaped cross-section, as seen in FIG. 2b, wherein engagement members engage totally around the longitudinal sides and the bottom part and wherein the engagement members thus form sides of the O-shape. A very strong connection that can withstand large torque is formed between the mounting head 8 and the connecting device 7, due to that the connecting device 7 at the location of its attachment to the mounting head 8 is in its entirety located in the mounting head 8, because of the engaging members of the mounting head 8 engaging around longitudinal sides and the bottom part of the connecting device 7.

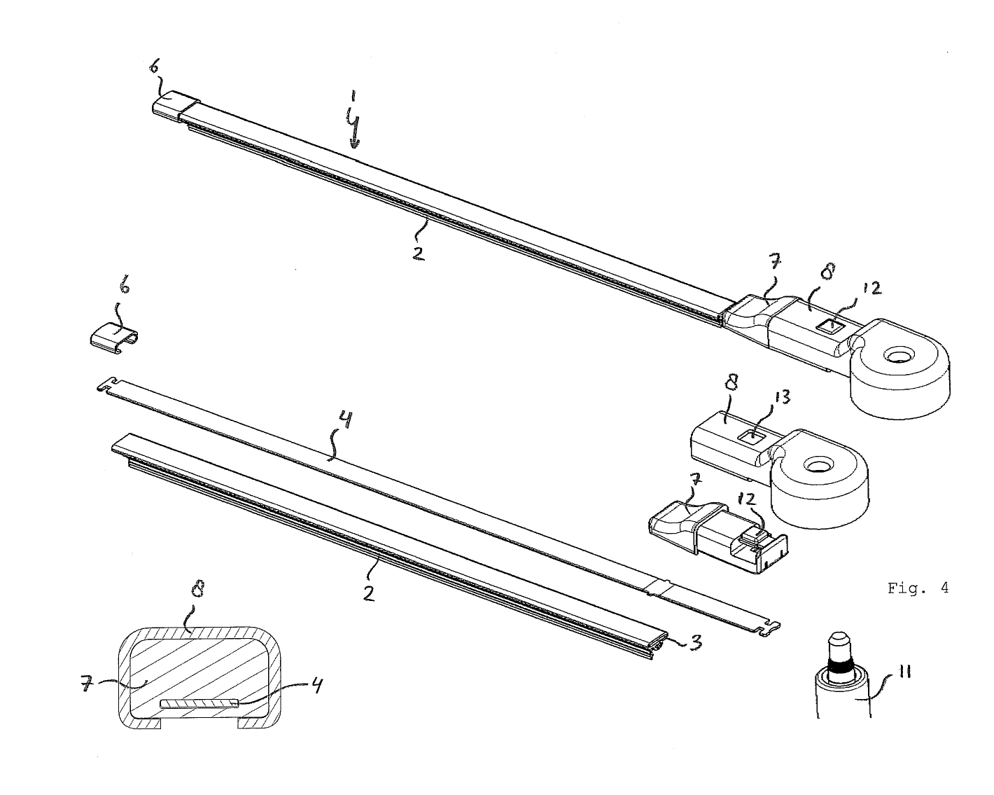

FIG. 4 shows another embodiment of a windscreen wiper device 1 according to the invention, wherein a central longitudinal groove 3 is formed in the wiper blade 2, in which a single longitudinal strip 4 is fitted.

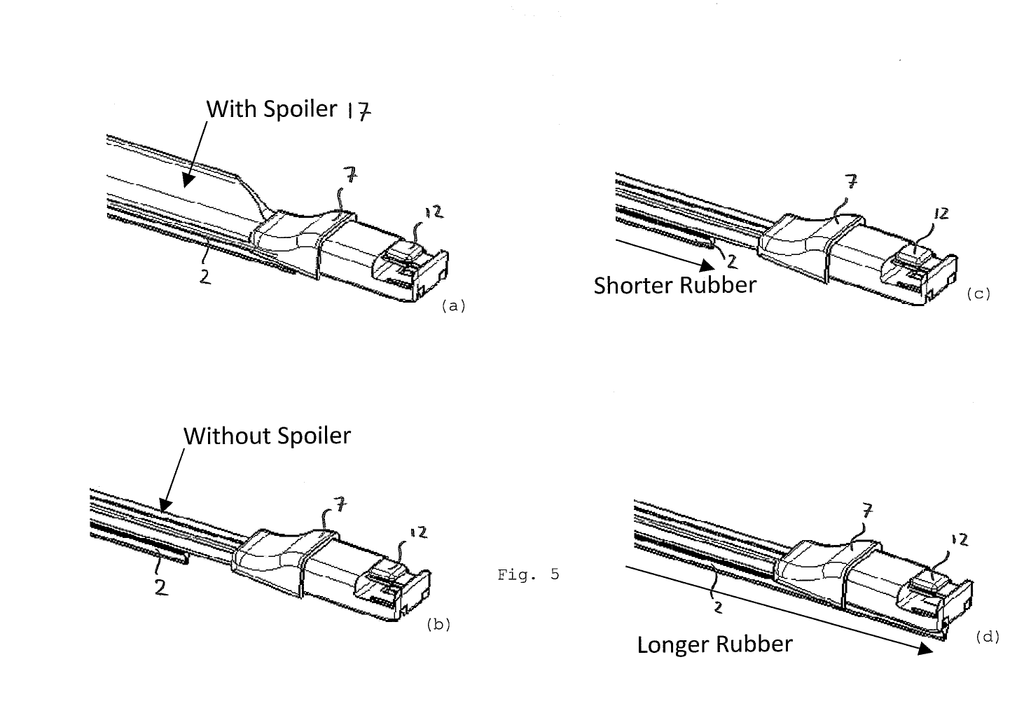

FIG. 5 relates to several views of the wiper blade 2 of FIGS. 1, 2 and 3. As can be seen, the wiper blade 2 may be equipped with or without a spoiler 17 (FIGS. 5a and 5b), while the wiper blade 2 as such may or may not extend under the connecting device 7 (FIGS. 5c and 5d).

The invention is not restricted to the variants shown in the drawing, but it also extends to other embodiments that fall within the scope of the appended claims.

1. A windscreen wiper device, particularly for automobiles, comprising an elastic, elongated carrier element, as well as an elongated wiper blade of a flexible material, which can be placed in abutment with a windscreen to be wiped, which wiper blade is of the flat blade type and includes at least one groove, in which groove a longitudinal strip of the carrier element is disposed, wherein said windscreen wiper device further comprises a mounting head for transferring a reciprocal movement to said wiper blade, said windscreen wiper device further comprises a connecting device for detachably connecting said wiper blade directly to said mounting head, wherein said connecting device is positioned near one end of said wiper blade, and wherein said connecting device, at the location of its attachment to said mounting head, is located in its entirety inside said mounting head.

2. A windscreen wiper device according to claim 1, wherein said mounting head, at the location of its attachment to said connecting device, comprises engaging members engaging around longitudinal sides and around a bottom of said connecting device, so that said connecting device is mounted in a channel formed by said engaging members.

3. A windscreen wiper device according to claim 1, wherein said mounting head has an at least substantially U-shaped cross-section at the location of its attachment to said connecting device, wherein said engaging members comprise legs of said U-shaped cross-section, and wherein each leg at the free end thereof comprises inwardly bended edges engaging around said bottom of said connecting device.

4. A windscreen wiper device according to claim 1, wherein said mounting head has an at least substantially O-shaped cross-section at the location of its attachment to said connecting device, wherein said engaging members comprise sides of said O-shaped cross-section.

5. A windscreen wiper device according to claim 1, wherein said strip and said connecting device are slidably connected by means of a snap connection.

6. A windscreen wiper device according to claim 5, wherein said snap connecting comprises at least one protrusion extending laterally from a longitudinal edge of said strip, said protrusion being located between stops on the connecting device.

7. A windscreen wiper device according to claim 5, wherein said snap connecting comprises at least two stops extending laterally from a longitudinal edge of said strip, said stops being located on opposite sides of a protrusion on the connecting device.

8. A windscreen wiper device according to claim 6, wherein said protrusion and/or said stops of said strip extend laterally from the interior or exterior edge of said strip.

9. A windscreen wiper device according to claim 1, wherein said windscreen wiper device further comprises a connecting piece positioned near the other end of said wiper blade and connected to one end of said longitudinal strip.

10. A windscreen wiper device according to claim 1, wherein said longitudinal strip is biassed in such a way that its curvature near the connecting device is larger than its curvature near the other end of said wiper blade.

11. A windscreen wiper device according to claim 1, wherein the interconnection between the mounting head and the wiper blade does not allow any pivotal movement.

12. A windscreen wiper device according to claim 1, wherein said mounting head is fixed for rotation to a shaft, and wherein said shaft is rotatable alternately in a clockwise and in a counter-clockwise sense carrying said mounting head into rotation.

13. A windscreen wiper device according to claim 1, wherein said mounting head is fixed for translation to a carriage, and wherein said carriage can be translated alternately in a one linear direction and in another counter linear direction carrying said mounting head into translation.

14. A windscreen wiper device according to claim 1, wherein said connecting device comprises at least one resilient tongue engaging in a correspondingly shaped hole provided in said mounting head, and wherein said resilient tongue is movable between a outward position retaining said wiper blade onto said mounting head and an inward position releasing said wiper blade from said mounting head.

15. A windscreen wiper device according to claim 14, wherein said hole is provided in a base of the U-shaped or O-shaped cross-section of said mounting head.
